(19) United States
(12) Patent Application Publication
(10) Pub. No.: US 2025/0233364 A1
(43) Pub. Date: Jul. 17, 2025

(54) ELECTRICAL CONNECTOR, CABLE, AND CONNECTION ASSEMBLY

(71) Applicant: SUMITOMO ELECTRIC INDUSTRIES, LTD., Osaka (JP)

(72) Inventors: Shun ENDO, Osaka-shi (JP); Yasunori ASANO, Osaka-shi (JP); Takeshi INOUE, Osaka-shi (JP); Toshihisa YOKOCHI, Osaka-shi (JP)

(73) Assignee: SUMITOMO ELECTRIC INDUSTRIES, LTD., Osaka (JP)

(21) Appl. No.: 19/018,596

(22) Filed: Jan. 13, 2025

(30) Foreign Application Priority Data
Jan. 16, 2024 (JP) 2024-004455

(51) Int. Cl. H01R 13/6471; H01R 12/71; H01R 12/77; H01R 13/516

(52) U.S. Cl. CPC H01R 13/6471; H01R 12/712; H01R 12/771; H01R 13/516

(57) ABSTRACT

An electrical connector includes a cable including a plurality of conductors and a covering portion, and a terminal disposed to face the end surface of each of the conductors and electrically connected to the conductors. The end surface of each of the conductors is inclined with respect to a perpendicular surface perpendicular to an extension direction of each of the conductors. The terminal includes a base end portion connected to the end surface of each of the conductors and a leading end portion located opposite to the base end portion. At least part of the terminal including the base end portion includes an inclined portion extending in a direction forming an obtuse angle with respect to each of the conductors, the direction being an inclination direction along the end surface.

### CROSS REFERENCE TO RELATED APPLICATIONS

This application claims priority based on Japanese Patent Application No. 2024-004455 filed on Jan. 16, 2024, and the entire contents of the Japanese patent application are incorporated herein by reference.

### TECHNICAL FIELD

The present disclosure relates to an electrical connector, a cable, and a connection assembly.

### BACKGROUND OF THE INVENTION

Patent literature 1 to patent literature 3 disclose techniques related to electrical connectors. For example, Patent Literature 1 discloses an electrical connector mounted on a substrate.
Patent literature 1: Japanese Unexamined Patent Application Publication No. 2016-129124
Patent literature 2: Japanese Unexamined Patent Application Publication No. 2002-117726
Patent literature 3: Japanese Unexamined Patent Application Publication No. 2019-207835

### SUMMARY OF THE INVENTION

An electrical connector according to an embodiment of the present disclosure includes a cable including a plurality of conductors and a covering portion, the plurality of conductors including at least one signal wire and at least one ground wire, the covering portion being configured to cover the plurality of conductors such that an end surface of each of the plurality of conductors is exposed, and a terminal disposed to face the end surface of each of the conductors and electrically connected to the conductors. The end surface of each of the conductors is inclined with respect to a perpendicular surface perpendicular to an extension direction of each of the conductors. The terminal includes a base end portion connected to the end surface of each of the conductors and a leading end portion located opposite to the base end portion. At least part of the terminal including the base end portion includes an inclined portion extending in a direction forming an obtuse angle with respect to each of the conductors, the direction being an inclination direction along the end surface.

### BRIEF DESCRIPTION OF THE DRAWINGS

FIG. 1 is a perspective view of a connection assembly, according to an embodiment.

FIG. 2 is a cross-sectional perspective view of the connection assembly shown in FIG. 1.

FIG. 3 is a cross-sectional view of the connection assembly shown in FIG. 1.

FIG. 4 is a perspective view of an electrical connector included in the connection assembly shown in FIG. 1.

FIG. 5 is a perspective view showing a cable, a plurality of terminals, and a holding member, which are provided in an end portion of the electrical connector shown in FIG. 4.

FIG. 6 is a cross-sectional view of FIG. 5.

FIG. 7 is an exploded perspective view of the cable and a plurality of terminals of FIG. 5.

FIG. 8A is a cross-sectional view showing the cable and the terminal constituting the electrical connector according to the embodiment. FIG. 8B is a cross-sectional view showing a cable and a terminal constituting an electrical connector according to the reference example.

### DETAILED DESCRIPTION

As an electrical connector mounted on a substrate, a connector in which a plurality of terminals are arranged in a multipolar manner inside a housing is considered. In such an electrical connector, one of a plurality of conductors inserted into the housing is electrically connected to a corresponding one of a plurality of conductor portions on the substrate through a corresponding one of a plurality of terminals arranged in a multipolar manner. In this case, a signal is transmitted between the electrical connector and the substrate through a transmission path passing through the conductor, the terminal, and the conductor portion. In such a transmission path, impedance mismatching may occur depending on the proximity of the paths before and after the change point of the path. In addition, a significant mutual inductance may be generated in one path due to a current flowing through the other path. As a result, the communication performance may be degraded.

The present disclosure provides an electrical connector, a cable, and a connection assembly that can improve communication performance.

### Description of Embodiments of Present Disclosure

First, the contents of embodiments of the present disclosure will be listed and explained.

[1] An electrical connector according to an embodiment includes a cable including a plurality of conductors and a covering portion, the plurality of conductors including at least one signal wire and at least one ground wire, the covering portion being configured to cover the plurality of conductors such that an end surface of each of the plurality of conductors is exposed, and a terminal disposed to face the end surface of each of the conductors and electrically connected to the conductors. The end surface of each of the conductors is inclined with respect to a perpendicular surface perpendicular to an extension direction of each of the conductors. The terminal includes a base end portion connected to the end surface of each of the conductors and a leading end portion located opposite to the base end portion. At least part of the terminal including the base end portion includes an inclined portion extending in a direction forming an obtuse angle with respect to each of the conductors, the direction being an inclination direction along the end surface.

The electrical connector includes a terminal electrically connected to the conductors, the terminal including a base end portion connected to the end surface of the conductor. The end surface of each of the conductor is inclined with respect to a perpendicular surface perpendicular to the extension direction of the conductors. At least a part of the terminal including the base end portion includes an inclined portion extending in a direction forming an obtuse angle with respect to each of the conductors, the direction being an inclination direction along the end surface. In this case, since the terminal can be connected in a state of being inclined at a gentle angle with respect to the conductor, for example, compared to a structure in which the terminal is connected perpendicularly to the conductor, it is possible to reduce the risk of forming paths that are close to each other, such as forming paths that bend at a right angle to each other in the transmission path that passes through the conductor and the terminal. Thus, it is possible to avoid the mutual inductance from being significantly generated in one path due to the current flowing through the other path by preventing the transmission paths from being formed with paths close to each other.

As a result, the loss of the signal propagating through the transmission path can be reduced, and thus the communication performance of the signal can be improved.

[2] The electrical connector of the above [1] may further include a conductor member disposed inside the covering portion or on a surface of the covering portion and connected to a ground. The terminal may include a signal terminal connected to the end surface of the signal wire, and a ground terminal connected to the end surface of the ground wire. The ground terminal may be connected to the conductor member, and the signal terminal may not be connected to the conductor member and be separated from the conductor member. In this case, the ground terminal is connected to the conductor member to be integrated, thereby stabilizing the ground. This makes it possible to reduce the influence of crosstalk and improve the communication performance of a signal propagating through a signal terminal or the like.

[3] In the electrical connector described in the above [2], the covering portion may include a shield layer surrounding the conductors. The conductor member may be disposed on a surface of the shield layer. The shield layer may be disposed at a position separated by a predetermined distance from the end surface of each of the conductors toward a side opposite to a side of the terminal in the extension direction. In this case, since contact between the signal terminal and the shield layer can be avoided, a decrease in communication performance due to conduction between the signal terminal and the shield layer can be avoided.

[4] In the electrical connector described in any one of the above [1] to [3], the conductors may include a plurality of the signal wires and a plurality of the ground wires arranged parallel to each other. In this case, since the plurality of signal wires can be arranged at high density, more signal wires can be connected to the connection target at the same time.

[5] In the electrical connector described in the above [4], the plurality of signal wires may include a first signal wire and a second signal wire disposed adjacent to each other. The plurality of ground wires may include a first ground wire and a second ground wire each disposed at a position such that the first signal wire and the second signal wire are interposed between the first ground wire and the second ground wire. The first signal wire and the second signal wire adjacent to each other can constitute a differential signal wire. In this case, the currents flowing through the first signal wire and the second signal wire are in opposite phases, and for example, a part of the signal propagating from the first signal wire to the first ground wire and going around to the conductor member is canceled by a part of the signal propagating from the second signal wire to the second ground wire and going around to the conductor member. As a result, the influence of crosstalk can be reduced more effectively, and thus the communication performance of signals can be further improved.

[6] In the electrical connector described in any one of the above [1] to [5], an end surface of the covering portion at which the end surface of each of the conductors is exposed may be inclined with respect to the perpendicular surface so as to be along the end surface of each of the conductors, and the end surface of the covering portion and the end surface of each of the conductors may be disposed on an identical plane. In this case, the area of the connection surface between the terminal and the cable can be increased, and thus, the electrical connection between the terminal and the conductor can be stabilized. Furthermore, as in the above-described structure, the end surface of the conductor is not protruded from the end surface of the covering portion, and thus it is possible to avoid the occurrence of a stub (branching of a signal) due to the conductor intersecting with the terminal, and to suppress a decrease in communication performance due to the stub.

[7] In the electrical connector described in any one of the above [1] to [6], the terminal may further include an intersecting portion connected to the inclined portion and extending in a direction intersecting the inclined portion. The intersecting portion may be inclined so as to form an obtuse angle with respect to the inclined portion. In this case, it is possible to avoid a path that is bent at a right angle from being formed in the terminal itself. This can reduce the risk of forming paths close to each other in the transmission path passing through the conductor and the terminal, and thus can reduce the loss of a signal due to mutual inductance.

[8] In the electrical connector described in any one of the above [1] to [7], the leading end portion of the terminal may be configured to be elastically deformable. In this case, when the electrical connector is mounted on the substrate, the connection of the terminal to the conductor portion of the substrate can be stabilized.

[9] The electrical connector described in any one of the above [1] to [8] may further include a housing configured to house an end portion of the cable and a plurality of the terminals, and a holding member housed in the housing and configured to, in a state of being fixed to the housing, collectively hold the plurality of terminals. In this structure, when the electrical connector is mounted on the substrate, the leading end portion of each terminal can be connected to the conductor portion of the substrate, with the holding member holding the plurality of terminals as a fulcrum. In this case, the distance from the deformation fulcrum of the terminal to the conductor portion can be shortened as compared with the case where the leading end portion of each terminal is connected to the conductor portion of the substrate, with the end surface of the conductor to which the base end portion of each terminal is connected as the fulcrum. As described above, the position of the leading end portion of the terminal connected to the conductor portion can be stabilized by lowering the deformation fulcrum of the terminal, and thus the contact pressure of the terminal with respect to the conductor portion can be appropriately maintained. Further, the holding member collectively holds the plurality of terminals, so that the contact pressure of each terminal can be made uniform.

[10] In the electrical connector described in the above [9], each of the plurality of terminals includes as the inclined portion, a first inclined portion and a second inclined portion, and an intermediate portion disposed between the first inclined portion and the second inclined portion and configured to connect the first inclined portion and the second inclined portion to each other. The holding member is configured to collectively hold the intermediate portions of the plurality of terminals. In this case, since the plurality of terminals can be stably held by the holding member, the contact pressure of each terminal can be more reliably maintained.

[11] The electrical connector described in any one of the above [1] to [10] may include as the cable, a first cable and a second cable. The leading end portion of each of a plurality of the terminals connected to the first cable may be disposed at a position shifted in the extension direction from the leading end portion of each of a plurality of the terminals connected to the second cable. In this case, the plurality of terminals of each of the first cable and the second cable can be arranged at a higher density.

[12] A cable according to an embodiment includes a plurality of conductors including at least one signal wire and at least one ground wire, and a covering portion configured to cover the plurality of conductors such that an end surface of each of the plurality of conductors is exposed. The end surface of each of the plurality of conductors is inclined with respect to a perpendicular surface perpendicular to an extension direction of each of the conductors. According to this cable, the terminal can be connected to the conductor in a state of being inclined at a gentle angle, and thus, the same effect as described above can be achieved.

[13] In the cable described in the above [12], the conductors may include a plurality of the signal wires and a plurality of the ground wires arranged parallel to each other. In this case, since the plurality of signal wires can be arranged at high density, more signal wires can be connected to the connection target at the same time.

[14] A connection assembly according to an embodiment includes the electrical connector described in any one of the above [1] to [11], a substrate including a conductor portion electrically connected to the leading end portion of the terminal, the substrate being configured such that the electrical connector is mounted on the substrate. Since the connection assembly includes the above-described electrical connector, the connection assembly has the same effect as described above.

### Details of Embodiments of Present Disclosure

Specific examples of an electrical connector, a cable, and a connection assembly according to embodiments of the present disclosure will be described below with reference to the drawings. In the following description, the same elements or elements having the same functions are denoted by the same reference numerals, and redundant description will be appropriately omitted. The present disclosure is not limited to these examples, but is defined by the scope of the claims, and is intended to include all modifications within the meaning and scope equivalent to the scope of the claims.

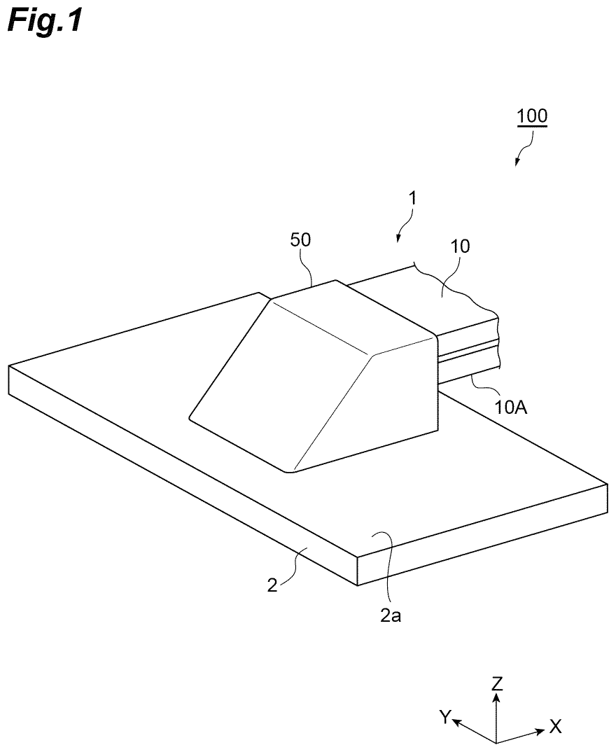

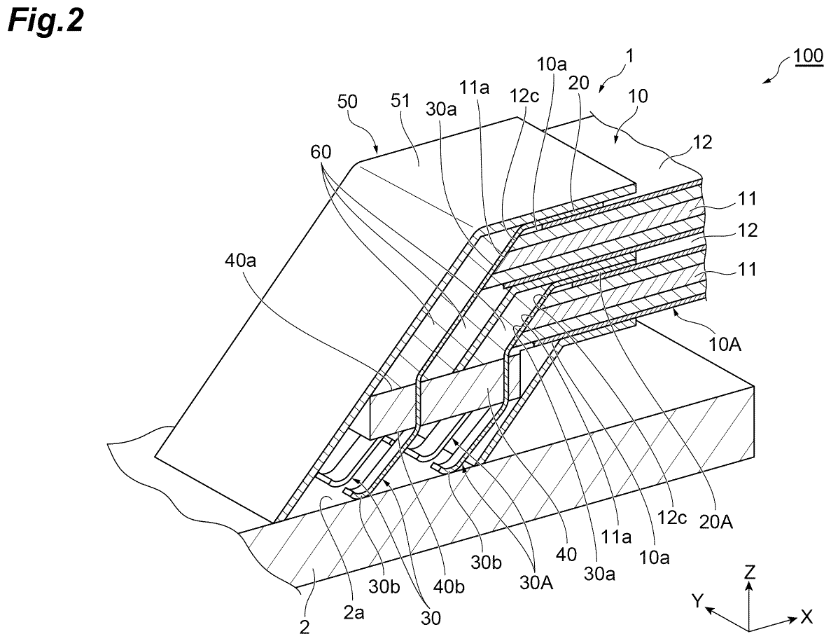

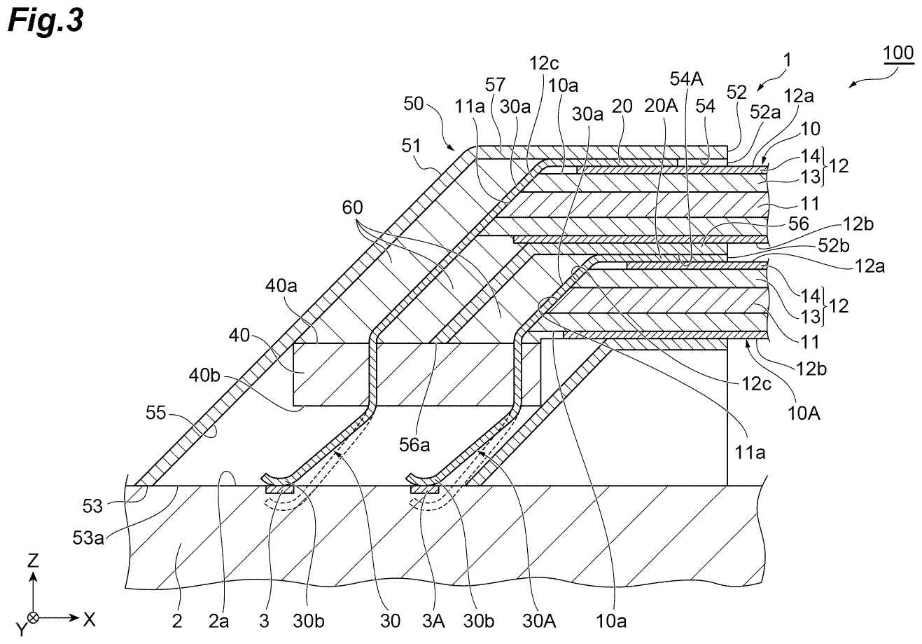

FIG. 1 is a perspective view of a connection assembly 100 according to an embodiment. FIG. 2 is a cross-sectional perspective view of connection assembly 100. FIG. 3 is a cross-sectional view of connection assembly 100. In each drawing, an XYZ orthogonal coordinate system is shown for convenience of description. The X direction, the Y direction, and the Z direction intersect (for example, are orthogonal to) each other.

As shown in FIGS. 1 to 3, connection assembly 100 includes, for example, an electrical connector 1 and a substrate 2 on which electrical connector 1 is mounted. Substrate 2 is a plate-like member with the Z direction as the thickness direction. Substrate 2 includes a main surface 2a on which electrical connector 1 is disposed. Main surface 2a extends along the X direction and the Y direction, for example, and faces electrical connector 1 in the Z direction. Substrate 2 includes a plurality of electrode pads 3 and 3A (a plurality of conductor portions) on main surface 2a (see FIG. 3). The plurality of electrode pads 3 are arranged in a line along the Y direction. The plurality of electrode pads 3A are arranged in a line along the Y direction at positions separated from the plurality of electrode pads 3 in the X direction.

As shown in FIGS. 2 and 3, electrical connector 1 includes, for example, cables 10 and 10A, ground bars 20 and 20A (conductor members), a plurality of terminals 30 and 30A, a holding member 40, and a housing 50. In the embodiment, two (a plurality of) cables 10 and 10A are provided, but one or more cables may be provided. Cable 10 (first cable) and cable 10A (second cable) are arranged so as to overlap in the Z direction over main surface 2a of substrate 2. Cable 10A is arranged at a position closer to main surface 2a than cable 10 in the Z direction. An end portion 10a of cable 10 is disposed at a position protruding in the X direction from end portion 10a of cable 10A. Ground bar 20 and the plurality of terminals 30 are provided for one cable 10, and ground bar 20A and the plurality of terminals 30A are provided for another cable 10A.

The plurality of terminals 30 provided in cable 10 are arranged at positions facing end portion 10a of cable 10 in the X direction, and are arranged in a row along the Y direction. The plurality of terminals 30 extend from a position facing end portion 10a of cable 10 toward the plurality of electrode pads 3 (see FIG. 3) of substrate 2. The plurality of terminals 30A provided in cable 10A are arranged at positions facing end portion 10a of cable 10A in the X direction, and are arranged in parallel along the Y direction at positions separated from the plurality of terminals 30 in the X direction. The plurality of terminals 30A extend from a position facing end portion 10a of cable 10A toward the plurality of electrode pads 3A (see FIG. 3) of substrate 2.

Cables 10 and 10A have, for example, the same structure as each other, and ground bar 20 and the plurality of terminals 30 provided in cable 10 also have the same structure as ground bar 20A and the plurality of terminals 30A provided in cable 10A, respectively. The plurality of terminals 30 have the same structure as terminals 30A except that terminals 30 have overall lengths different from those of terminals 30A. Hereinafter, in order to avoid a redundant description, a structure of cable 10 will be mainly described.

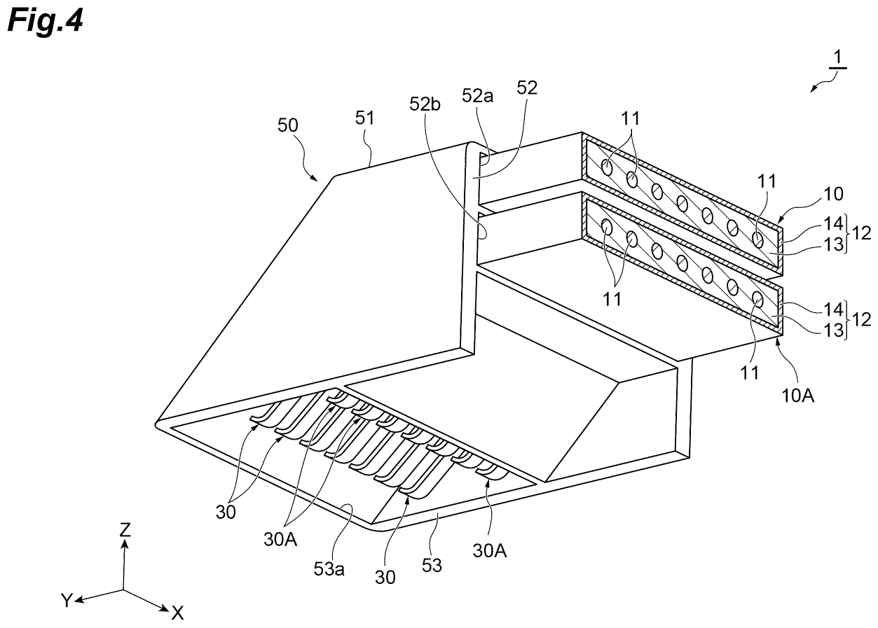

FIG. 4 is a perspective view of electrical connector 1. FIG. 4 shows a cross section of cable 10 cut along the YZ plane. As shown in FIG. 4, cable 10 includes a plurality of electric wires 11 (a plurality of conductors) and a covering portion 12 covering the plurality of electric wires 11. Each of the plurality of electric wires 11 is a member for transmitting electric power or an electric signal, and is formed of, for example, metal such as copper. The plurality of electric wires 11 extend along the X direction and are arranged in parallel along the Y direction. The plurality of electric wires 11 have, for example, a circular shape in a cross section perpendicular to the X direction which is the extension direction of electric wires 11. Covering portion 12 is a member that covers the plurality of electric wires 11 such that end surface 11a (see FIG. 3) of each of the plurality of electric wires 11 is exposed. The material of covering portion 12 is, for example, a resin such as polyester. Cable 10 is formed by integrating the plurality of electric wires 11 arranged in the Y direction with covering portion 12. Cable 10 is, for example, a flexible flat cable (FFC).

As shown in FIGS. 3 and 4, covering portion 12 includes, for example, an electrically insulating layer 13 surrounding the plurality of electric wires 11 and a shield layer 14 surrounding electrically insulating layer 13. The material of electrically insulating layer 13 is, for example, a resin such as polyethylene or polypropylene. Electrically insulating layer 13 may be formed of, for example, a plurality of layers stacked on each other. The material of shield layer 14 is, for example, metal such as copper or aluminum. Shield layer 14 is electrically connected to the ground, and has a function of blocking noise that enters the plurality of electric wires 11 from the outside of cable 10. Shield layer 14 is bonded to electrically insulating layer 13 with, for example, an adhesive. The surface of shield layer 14 constitutes, for example, the outermost surface of covering portion 12. Covering portion 12 may further include another protective layer outside the shield layer.

As shown in FIG. 3, covering portion 12 includes an upper surface 12a and a lower surface 12b as outermost surfaces. Upper surface 12a and lower surface 12b extend along the X direction and the Y direction, respectively, and are arranged along the Z direction, for example. Lower surface 12b is disposed so as to face main surface 2a of substrate 2, and upper surface 12a is disposed so as to face in a direction opposite to the direction facing main surface 2a of substrate 2.

Ground bar 20 is a plate-shaped conductor member having conductivity. The material of ground bar 20 is, for example, metal such as copper or aluminum. Ground bar 20 extends along, for example, the X direction and the Y direction, and is disposed so as to overlap the surface of shield layer 14 (i.e., upper surface 12a of covering portion 12) in the Z direction. Ground bar 20 is in contact with the surface of shield layer 14 and is electrically connected to shield layer 14. Thus, ground bar 20 is electrically connected to the ground through shield layer 14. The shape of ground bar 20 viewed along the Z direction is, for example, a rectangular shape with the Y direction as the longitudinal direction. Ground bar 20 is disposed on, for example, upper surface 12a included in end portion 10a of cable 10.

Each of the plurality of terminals 30 is formed of metal such as copper, and is used as a signal wire or a ground wire. The plurality of terminals 30 electrically connect the plurality of electric wires 11 and the plurality of electrode pads 3, respectively. Each terminal 30 includes a base end portion 30a connected to end surface 11a of electric wire 11 and a leading end portion 30b connected to electrode pad 3. In this specification, the term “connection” includes both a case where two elements are directly connected to each other and a case where two elements are indirectly connected to each other through another member.

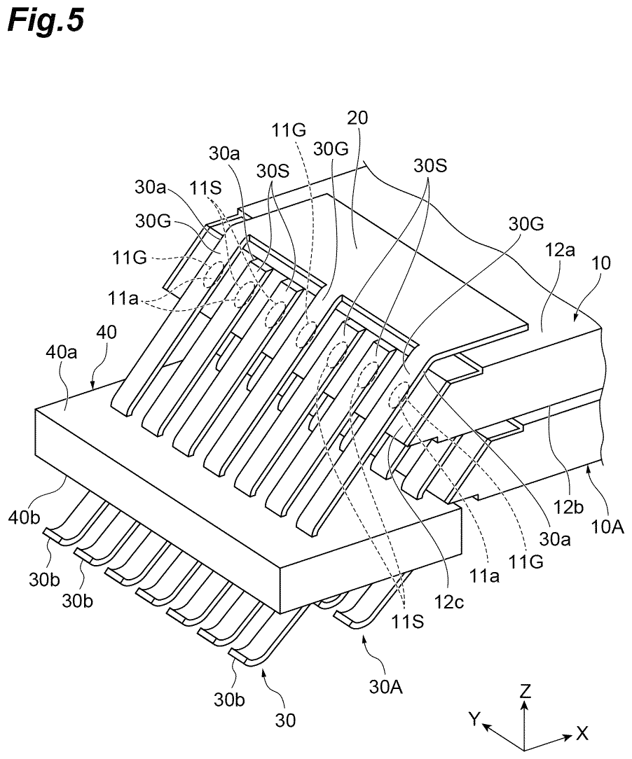

Base end portion 30a of terminal 30 faces end surface 11a of electric wire 11 in the X direction, and is connected to end surface 11a through, for example, solder. The connection between base end portion 30a and end surface 11a is not limited to the solder connection, and other connections such as crimping or welding (for example, laser welding or thermal welding) may be used. Thus, base end portion 30a may be in direct contact with end surface 11a of electric wire 11, or may be in indirect contact with end surface 11a through another member. Although details will be described later, a plurality of ground terminals 30G used as ground wires among the plurality of terminals 30 are connected to ground bar 20 disposed on upper surface 12a of covering portion 12 and are integrated with ground bar 20 (see FIG. 5). On the other hand, a plurality of signal terminals 30S used as signal wires among the plurality of terminals 30 are not connected to ground bar 20. That is, signal terminal 30S is disconnected from ground bar 20.

Leading end portion 30b of terminal 30 faces electrode pad 3 in the Z direction and is connected to electrode pad 3 through, for example, solder. The connection between leading end portion 30b and electrode pad 3 is not limited to the solder connection, and other connections such as crimping or welding (for example, laser welding or thermal welding) may be used. Thus, leading end portion 30b may be in direct contact with electrode pad 3, or may be in indirect contact with electrode pad 3 through another member.

Housing 50 is a member for housing end portion 10a of cable 10, ground bar 20, the plurality of terminals 30, and holding member 40. Housing 50 includes an outside shell 51 made of metal, for example. Outside shell 51 includes a side surface 52 in which an opening 52a and an opening 52b are formed, and a bottom surface 53 in which an opening 53a is formed.

Side surface 52 of outside shell 51 is a plane extending in a direction intersecting the X direction, and is disposed, for example, perpendicular to main surface 2a of substrate 2. Opening 52a and opening 52b formed in side surface 52 have, for example, a rectangular shape with the Y direction as the longitudinal direction, and are formed so as to be arranged along the Z direction. End portion 10a of cable 10 is inserted into opening 52a in the X direction. End portion 10a of cable 10A is inserted into opening 52b in the X direction. Bottom surface 53 of outside shell 51 is a plane extending along the X direction and the Y direction along main surface 2a of substrate 2, and faces main surface 2a in the Z direction. Bottom surface 53 is directly or indirectly fixed to main surface 2a. Opening 53a formed in bottom surface 53 has, for example, a rectangular shape with the Y direction as the longitudinal direction in. Leading end portion 30b of each of the plurality of terminals 30 and 30A is disposed in opening 53a.

Outside shell 51 includes, on the inside, an insertion hole 54 extending from opening 52a, an insertion hole 54A extending from opening 52b, and a housing hole 55 communicating with insertion holes 54 and 54A and extending to opening 53a of bottom surface 53. Insertion holes 54 and 54A extend linearly from side surface 52 along the X direction, and then incline so as to bend from the X direction toward substrate 2 in the Z direction, for example. Housing hole 55 extends along the direction in which insertion holes 54 and 54A are inclined. Insertion holes 54 and 54A are partitioned in the Z direction by a partition wall 56. Partition wall 56 is integrated with an outside wall 57 that constitutes the outer shell of outside shell 51. Partition wall 56 and outside wall 57 constitute outside shell 51. Partition wall 56 extends from side surface 52 on the inside of outside wall 57, and a leading end 56a of partition wall 56 is disposed at a position that does not reach bottom surface 53. Leading end 56a of partition wall 56 is disposed at a position facing main surface 2a of substrate 2 in the Z direction on the inside of outside wall 57.

The inside of insertion holes 54 and 54A is filled with a resin material 60. Resin material 60 is formed of, for example, a resin such as polyphenylene sulfide (PPS). Resin material 60 is formed by pouring resin into insertion holes 54 and 54A through potting or the like, for example. Resin material 60 is fixed to the inner surfaces of insertion holes 54 and 54A, for example, and is configured as a part of housing 50.

Holding member 40 is disposed in housing hole 55. Holding member 40 is, for example, a plate-like resin member with in the Z direction as the thickness direction. Holding member 40 is formed of, for example, a resin material (insulating material) having electrical insulation properties. The material of holding member 40 may be, for example, a resin having a higher hardness than resin material 60. Holding member 40 is disposed at the boundary between insertion holes 54 and 54A and housing hole 55 inside outside shell 51, and is disposed so as to close insertion holes 54 and 54A from housing hole 55. Holding member 40 includes, for example, an upper surface 40a that closes insertion holes 54 and 54A and a lower surface 40b that faces in a direction opposite to the direction facing upper surface 40a. Upper surface 40a is fixed to resin material 60 injected into insertion holes 54 and 54A, and leading end 56a of partition wall 56. Lower surface 40b faces main surface 2a of substrate 2 in the Z direction with a predetermined distance therebetween.

The plurality of terminals 30 and 30A are inserted into holding member 40. The plurality of terminals 30 and 30A are collectively held by holding member 40. Leading end portion 30b of each of terminals 30 and 30A protrudes from lower surface 40b of holding member 40 toward main surface 2a, and is connected to each of electrode pads 3 and 3A of substrate 2. Holding member 40 is formed by, for example, insert molding. As a result, holding member 40 is fixed to housing 50 including resin material 60. The method of forming holding member 40 is not limited to the above-described example, and may be another method. For example, terminals 30 and 30A may be attached to a holding member that is molded in advance separately from housing 50, and then holding member 40 may be fixed to housing 50 with, for example, an adhesive.

Leading end portion 30b of each of terminals 30 and 30A is configured to be elastically deformable in the Z direction, and has, for example, a J shape. Leading end portion 30b is in contact with electrode pad 3 in an elastically deformed state. For example, leading end portion 30b protrudes from bottom surface 53 of housing 50 before being contact with electrode pad 3 (see the shape indicated by the dotted line in FIG. 3).

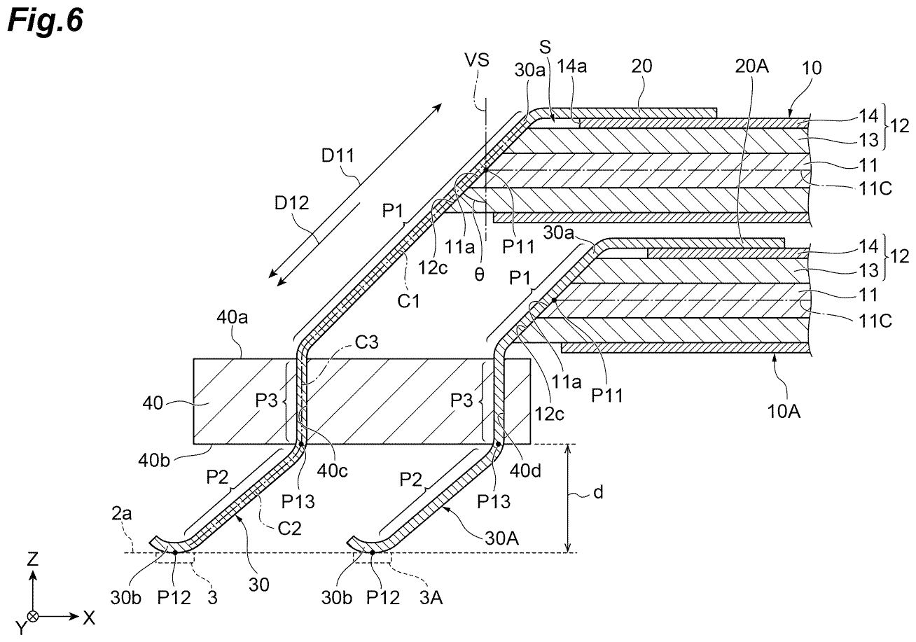

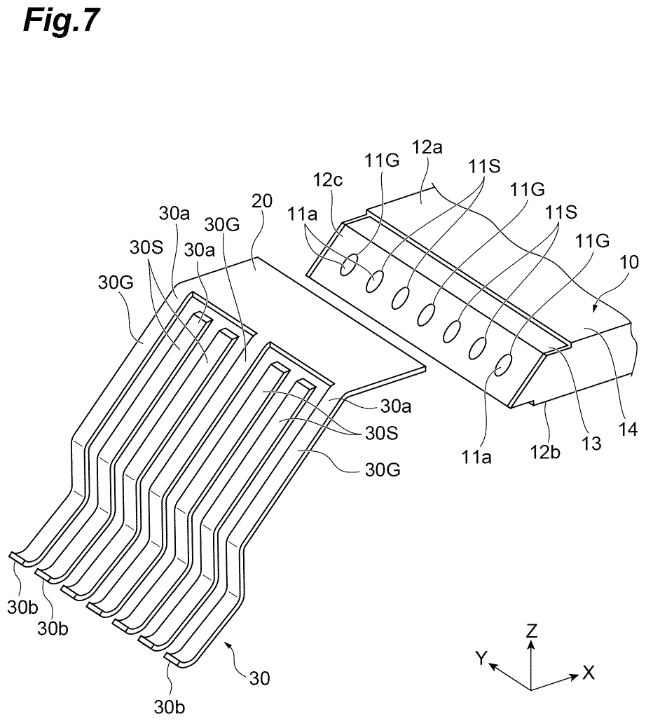

Referring to FIGS. 5 to 7, the structure of the end portion of electrical connector 1 will be described in more detail. FIG. 5 is a perspective view showing cables 10 and 10A, the plurality of terminals 30 and 30A, and holding member 40, which are provided in the end portion of electrical connector 1. FIG. 6 is a cross-sectional view of the structure shown in FIG. 5, taken along the XZ plane passing through a ground wire 11G. FIG. 7 is an exploded perspective view showing cable 10 and the plurality of terminals 30 in FIG. 5.

As illustrated in FIGS. 5 and 7, the plurality of electric wires 11 include, for example, a plurality of signal wires 11S and the plurality of ground wires 11G. The arrangement of each of signal wires 11S and each of ground wires 11G is appropriately determined according to the signal to be transmitted. In the embodiment, two signal wires 11S and 11S (first signal wire and second signal wire) are arranged in parallel, and two ground wires 11G and 11G (first ground wire and second ground wire) are arranged at positions sandwiching two signal wires 11S and 11S, respectively. As a result, one signal wire 11S is adjacent to one ground wire 11G, and the other signal wire 11S is adjacent to the other ground wire 11G. Two signal wires 11S and 11S adjacent to each other allow currents of opposite phases to flow therethrough, and transmit signals by differential transmission in which signals are transmitted by a potential difference between two signal wires 11S and 11S. The arrangement of signal wires 11S and ground wires 11G is not limited to the above-described example, and may be another arrangement.

The plurality of terminals 30 include, for example, the plurality of signal terminals 30S and the plurality of ground terminals 30G. The plurality of signal terminals 30S are terminals used as signal wires. The plurality of ground terminals 30G are terminals used as ground wires. The plurality of ground terminals 30G are arranged along the Y direction so as to correspond to the plurality of ground wires 11G, respectively, and are electrically connected to the plurality of ground wires 11G, respectively. Base end portion 30a of each of the plurality of ground terminals 30G is disposed to face end surface 11a of each of the plurality of ground wires 11G and is connected to end surface 11a of each of the plurality of ground wires 11G through solder. Base end portions 30a of the plurality of ground terminals 30G are connected to ground bar 20 disposed on upper surface 12a of covering portion 12 and are integrated with ground bar 20. Thus, the plurality of ground terminals 30G are electrically connected to the ground through ground bar 20.

The plurality of signal terminals 30S are arranged along the Y direction so as to correspond to end surface 11a of the plurality of signal wires 11S, respectively, and are electrically connected to the plurality of signal wires 11S, respectively. Base end portion 30a of each of the plurality of signal terminals 30S is disposed to face end surface 11a of each of the plurality of signal wires 11S and is connected to end surface 11a of each of the plurality of signal wires 11S through solder. Base end portions 30a of the plurality of signal terminals 30S are not connected to ground bar 20, and are separated from ground bar 20. Thus, the plurality of signal terminals 30S are electrically independent of the plurality of ground terminals 30G and ground bar 20.

As shown in FIG. 6, end surface 11a of each electric wire 11 is inclined with respect to a perpendicular surface VS perpendicular to the X direction in which electric wire 11 extends. Perpendicular surface VS may be, for example, a virtual surface parallel to the YZ plane and may be perpendicular to a center axis 11C of electric wire 11. End surface 11a is inclined with respect to both the Z direction and the X direction so that, for example, the closer to lower surface 12b along the Z direction, the farther from cable 10 in the X direction in a cross section (cross section in FIG. 6) passing through center axis 11C of electric wire 11. An inclination angle θ of end surface 11a with respect to perpendicular surface VS may be, for example, from 10 degrees to 80 degrees.

An end surface 12c of covering portion 12 is inclined with respect to perpendicular surface VS so as to be along end surface 11a. End surface 12c and end surface 11a are disposed on the identical plane. That is, end surface 12c is flush with end surface 11a. End surface 12c may be, for example, an end surface of electrically insulating layer 13 of covering portion 12 in the X direction. An end surface of electrically insulating layer 13 in the X direction protrudes from an end surface of shield layer 14 in the X direction, and forms end surface 12c of covering portion 12. Shield layer 14 of covering portion 12 is disposed at a position by a predetermined distance from end surface 11a of electric wire 11 and end surface 12c of covering portion 12 toward a side opposite to a side of terminal 30 in the X direction. When the direction from end surface 11a of electric wire 11 toward terminal 30 in the X direction is defined as the front and the opposite direction is defined as the rear, shield layer 14 is disposed at a position shifted rearward from end surfaces 11a and 12c. That is, an end surface 14a of shield layer 14 in the X direction is shifted backward from end surfaces 11a and 12c by a predetermined distance. As a result, a gap S is formed between end surface 14a of shield layer 14 and terminal 30. In this manner, shield layer 14 is not in contact with terminal 30 and is separated from terminal 30. Thus, shield layer 14 is not connected to signal terminal 30S, and maintains a state of non-conduction with signal terminal 30S.

Each of the plurality of terminals 30 includes, for example, a first inclined portion P1, a second inclined portion P2, and an intermediate portion P3 (intersecting portion). First inclined portion P1 is included in at least a part of terminal 30 including base end portion 30a. In the embodiment, first inclined portion P1 is a part of terminal 30 including base end portion 30a. First inclined portion P1 may be entire terminal 30 including base end portion 30a. First inclined portion P1 is disposed to face end surface 11a of electric wire 11 and is connected to end surface 11a through solder. First inclined portion P1 includes at least a connection point P11 connected to end surface 11a of electric wire 11. Connection point P11 may be, for example, an intersection of terminal 30 and center axis 11C of electric wire 11 or an intersection of terminal 30 and an extension line of center axis 11C. First inclined portion P1 extends on end surface 11a along an inclination direction D11 of end surface 11a. Inclination direction D11 is a direction along end surface 11a, that is, a direction inclined from perpendicular surface VS.

First inclined portion P1 extends, between connection point P11 and a connection point P12, along a direction D12 that forms an obtuse angle with respect to electric wire 11, direction D12 being parallel to inclination direction D11. Connection point P12 is a point at which terminal 30 is connected to electrode pad 3, and may be, for example, an intersection point of terminal 30 and a normal line of main surface 2a passing through the center of electrode pad 3. First inclined portion P1 forming an obtuse angle with respect to electric wire 11 means that the angle of a center axis C1 of first inclined portion P1 with respect to center axis 11C of electric wire 11 is in a range of greater than 90 degrees and less than 180 degrees. Direction D12 can also be referred to as a direction inclined with respect to both the Z direction and the X direction so that the closer to connection point P12 from connection point P11, the farther from cable 10 along the X direction in the cross section (cross section of FIG. 6) passing through center axis 11C of electric wire 11. First inclined portion P1 may also extend in a direction opposite to direction D12 on end surface 11a.

Second inclined portion P2 is arranged at a position farther from connection point P11 than first inclined portion P1 between connection point P11 and connection point P12. That is, second inclined portion P2 is located between first inclined portion P1 and connection point P12. Second inclined portion P2 extends along direction D12 along which first inclined portion P1 extends, for example. That is, second inclined portion P2 extends in parallel to first inclined portion P1. Second inclined portion P2 may extend along a direction different from direction D12 along which first inclined portion P1 extends.

Intermediate portion P3 is disposed between first inclined portion P1 and second inclined portion P2, and connects first inclined portion P1 and second inclined portion P2 to each other. Intermediate portion P3 extends in a direction intersecting with first inclined portion P1 and second inclined portion P2. Intermediate portion P3 is inclined so as to form an obtuse angle with respect to first inclined portion P1 and second inclined portion P2, for example. That is, the angle formed by a center axis C3 of intermediate portion P3 and center axis C1 of first inclined portion P1 is in a range of greater than 90 degrees and less than 180 degrees, and the angle formed by center axis C3 of intermediate portion P3 and a center axis C2 of second inclined portion P2 is in a range of greater than 90 degrees and less than 180 degrees. Intermediate portion P3 extends, for example, in a direction perpendicular to center axis 11C of electric wire 11, that is, in a direction along perpendicular surface VS. Intermediate portion P3 extends from first inclined portion P1 to second inclined portion P2 along the Z direction in the cross section (cross section of FIG. 6) passing through center axis 11C of electric wire 11. The length of intermediate portion P3 along the Z direction is, for example, the same as the thickness of holding member 40 along the Z direction, or longer than the thickness of holding member 40 along the Z direction.

Holding member 40 is disposed between connection point P11 and connection point P12, and collectively holds intermediate portions P3 of the plurality of terminals 30 and 30A. Holding member 40 includes, for example, a plurality of holding holes 40c and a plurality of holding holes 40d. The plurality of holding holes 40c are arranged in a line along the Y direction so as to correspond to the plurality of terminals 30, respectively. Intermediate portions P3 of the plurality of terminals 30 are inserted into the plurality of holding holes 40c, respectively. The plurality of holding holes 40d are arranged in a line along the Y direction so as to correspond to the plurality of terminals 30A, respectively. Intermediate portions P3 of the plurality of terminals 30A are inserted into the plurality of holding holes 40d, respectively. The plurality of holding holes 40c and 40d penetrate from lower surface 40a to upper surface 40b along the Z direction.

Holding member 40 collectively holds intermediate portions P3 of the plurality of terminals 30 and 30A in a state of being fixed to housing 50. Thus, leading end portion 30b of each of terminals 30 and 30A modifies lower surface 40b of holding member 40 as a fulcrum P13. Holding member 40 is disposed, for example, in parallel to main surface 2a of substrate 2, and a distance d between lower surface 40b of holding member 40 and main surface 2a is maintained constant. In this case, the length from fulcrum P13 to connection point P12 is maintained constant in each of terminals 30 and 30A, and the spring displacement amount of leading end portion 30b of each of terminals 30 and 30A with respect to each of electrode pads 3 and 3A is uniformized.

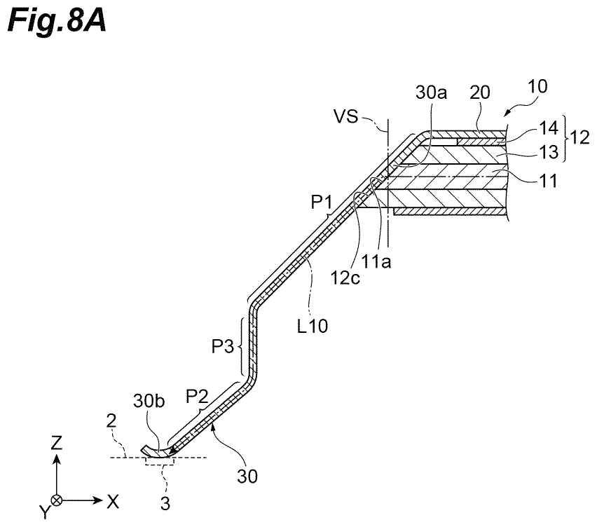

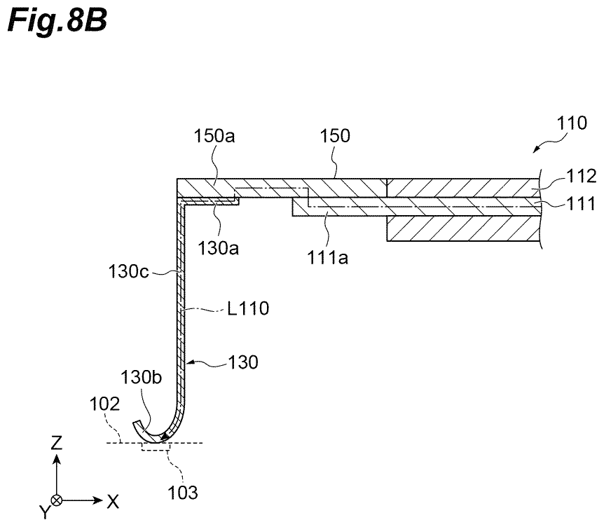

The effects achieved by electrical connector 1, cable 10, and the connection assembly according to the embodiment described above will be described. FIGS. 8A and 8B are cross-sectional views for explaining the effect of the embodiment. FIG. 8A is a cross-sectional view showing cable 10 and terminal 30 constituting electrical connector 1 according to the embodiment. FIG. 8B is a cross-sectional view showing a cable 110 and a terminal 130 constituting the electrical connector according to the reference example.

In the example shown in FIG. 8B, terminal 130 is arranged so as to be perpendicular to an electric wire 111 of cable 110, and is connected to electric wire 111 through a relay member 150. Relay member 150 is a member for relaying electrical connection between terminal 130 and electric wire 111, and is, for example, a paddle card. Relay member 150 is connected to the upper surface of electric wire 111 protruding from a covering portion 112. An end portion 150a of relay member 150 protrudes forward beyond an end portion 111a of electric wire 111. A base end portion 130a of terminal 130 is fixed to end portion 150a of relay member 150 and extends in the X direction along relay member 150. An intermediate portion 130c of terminal 130 is bent perpendicularly to base end portion 130a and extends toward a leading end portion 130b along the −Z direction. Leading end portion 130b of terminal 130 is connected to an electrode pad 103 of a substrate 102.

In the example shown in FIG. 8B, signals are transmitted between cable 110 and substrate 102 through a transmission path L110 passing through electric wire 111, relay member 150, terminal 130, and electrode pad 103. In such a transmission path, for example, there are paths that are bent at a right angle to each other, such as a connection portion between base end portion 130a and intermediate portion 130c of terminal 130. In this case, a significant mutual inductance may be generated in the path passing through base end portion 130a due to the current flowing through the path passing through intermediate portion 130c. As a result, impedance mismatch between these paths increases, and communication performance may be degraded.

In contrast, in electrical connector 1 according to the embodiment, as shown in FIG. 8A, end surface 11a of electric wire 11 is inclined from perpendicular surface VS, and first inclined portion P1 of terminal 30 is inclined along end surface 11a. In this case, since terminal 30 can be connected in a state of being inclined at a gentle angle with respect to electric wire 11, compared to a structure in which terminal 30 is connected perpendicularly to electric wire 11 (see FIG. 8B), it is possible to reduce the risk of forming paths that are close to each other, such as forming paths that bend at a right angle to each other in a transmission path L10 that passes through electric wire 11, terminal 30, and electrode pad 3. Thus, it is possible to avoid the mutual inductance from being significantly generated in one path (for example, a path passing through electric wire 11) due to the current flowing through the other path (for example, a path passing through first inclined portion P1 of terminal 30) by preventing transmission paths L10 from being formed with paths close to each other. As a result, the loss of the signal propagating through transmission path L10 can be reduced, and thus the communication performance of the signal can be improved. Furthermore, according to the embodiment, it is possible to simply form a structure in which terminal 30 is connected to electric wire 11 while increasing the area of the connection surface between first inclined portion P1 and end surface 11a by connecting first inclined portion P1 of terminal 30 to inclined end surface 11a of electric wire 11. For example, since terminal 30 can be directly connected to electric wire 11 without using relay member 150 as shown in FIG. 8B, the number of components can be reduced and the structure of electrical connector 1 can be simplified. Furthermore, if the structure in which terminals 30 are connected to electric wires 11 can be formed in a simple manner, it is possible to avoid the connection portions between terminals 30 and electric wires 11 from taking up more space than necessary, and thus it is possible to arrange terminals 30 in a limited space at a higher density.

As in the embodiment, the plurality of ground terminals 30G may be connected to ground bar 20 disposed on upper surface 12a of covering portion 12, and the plurality of signal terminals 30S may be spaced apart from ground bar 20. In this case, the plurality of ground terminals 30G is connected to ground bar 20 to be integrated, thereby stabilizing the ground. This makes it possible to reduce the influence of crosstalk and improve the communication performance of a signal propagating through signal terminal 30S or the like. Further, a plurality of ground wires G11 can be collectively connected to the ground through the plurality of ground terminals 30G and ground bar 20 by integrating the plurality of ground terminals 30G with ground bar 20 in this manner. In this case, the manufacturing process of electrical connector 1 can be simplified as compared with the case where the work of connecting the plurality of ground wires 11G to the ground one by one is required.

As in the embodiment, shield layer 14 may be disposed so as to be shifted by a predetermined distance from end surface 11a of electric wire 11 in the X direction away from terminal 30. In this case, since contact between signal terminal 30S and shield layer 14 can be avoided, a decrease in communication performance due to conduction between signal terminal 30S and shield layer 14 can be avoided.

As in the embodiment, the plurality of signal wires 11S may include signal wires 11S and 11S adjacent to each other, and the plurality of ground wires 11G may include ground wires 11G and 11G arranged at positions sandwiching signal wires 11S and 11S. Signal wires 11S and 11S adjacent to each other can constitute differential signal wires. In this case, the currents flowing through signal wires 11S and 11S are in opposite phases, and for example, a part of the signal propagating from one signal wire 11S to one ground wire 11G and going around to ground bar 20 is canceled by a part of the signal propagating from the other signal wire 11S to the other ground wire 11G and going around to ground bar 20. This makes it possible to more effectively reduce the influence of crosstalk, and thus to further improve the communication performance of signals.

As in the embodiment, end surface 12c of covering portion 12 may be inclined with respect to perpendicular surface VS so as to be along end surface 11a of electric wire 11, and end surface 12c and end surface 11a of electric wire 11 may be disposed on the identical plane. In this case, the area of the connection surface between terminal 30 and cable 10 can be increased, and thus, the electrical connection between terminal 30 and electric wire 11 can be stabilized. Furthermore, as in the above-described structure, end surface 11a of electric wire 11 is not protruded from end surface 12c of covering portion 12, and thus it is possible to avoid the occurrence of a stub (branching of a signal) due to electric wire 11 intersecting with terminal 30, and to suppress a decrease in communication performance due to the stub.

As in the embodiment, terminal 30 may further include intermediate portion P3 connected to first inclined portion P1 and extending in a direction intersecting first inclined portion P1, and intermediate portion P3 may be inclined so as to form an obtuse angle with respect to first inclined portion P1. In this case, it is possible to avoid a path that is bent at a right angle from being formed in terminal 30 itself. This can reduce the risk of forming paths close to each other in transmission path L10 passing through electric wire 11 and terminal 30, and thus can reduce the loss of a signal due to mutual inductance.

As in the embodiment, leading end portion 30b of terminal 30 may be configured to be elastically deformable. In this case, when electrical connector 1 is mounted on substrate 2, the connection of terminal 30 to electrode pad 3 of substrate 2 can be stabilized.

As in the embodiment, electrical connector 1 may include housing 50 for housing end portion 10a of cable 10 and the plurality of terminals 30, and holding member 40 housed in housing 50 and collectively holding the plurality of terminals 30 in a state of being fixed to housing 50. In this structure, when electrical connector 1 is mounted on substrate 2, leading end portion 30b of each terminal 30 can be connected to electrode pad 3 of substrate 2, with holding member 40 holding the plurality of terminals 30 as fulcrum P13. In this case, the distance from deformation fulcrum P13 of terminal 30 to electrode pad 3 can be shortened as compared with the case where leading end portion 30b of each terminal 30 is connected to electrode pad 3 of substrate 2, with end surface 11a of electric wire 11 to which base end portion 30a of each terminal 30 is connected as the fulcrum. As described above, the position of leading end portion 30b of terminal 30 connected to electrode pad 3 can be stabilized by lowering deformation fulcrum P13 of terminal 30, and thus the contact pressure of terminal 30 with respect to electrode pad 3 can be appropriately maintained. Further, holding member 40 collectively holds the plurality of terminals 30, so that the contact pressure of each terminal 30 can be made uniform. Further, when holding member 40 collectively holds the plurality of terminals 30 and 30A, terminals 30 and 30A having different lengths can be deformed with reference to same fulcrum P13, and thus the deformation amounts of terminals 30 and 30A from fulcrum P13 can be equalized.

As in the embodiment, terminal 30 may include first inclined portion P1, second inclined portion P2, and intermediate portion P3, and holding member 40 may collectively hold intermediate portions P3 of the plurality of terminals 30. In this case, since the plurality of terminals 30 can be stably held by holding member 40, the contact pressure of each terminal 30 can be more reliably maintained.

As in the embodiment, in electrical connector 1, leading end portions 30b of the plurality of terminals 30 connected to cable 10 may be arranged at positions shifted in the X direction with respect to leading end portions 30b of the plurality of terminals 30A connected to cable 10A. In this case, the plurality of terminals 30 and 30A can be arranged at a higher density.

Although the embodiments of the present disclosure have been described in detail, the present disclosure is not limited to the embodiments described above, and can be applied to various embodiments. For example, in the above embodiment, ground bar 20 is formed of a member different from shield layer 14 of cable 10. However, the ground bar (conductor member) may be integrated with the shield layer. That is, the ground bar may be disposed inside the covering portion of the cable and may be configured as a part of the shield layer. The ground bar does not necessarily have to be disposed on the upper surface of the covering portion, and may be disposed on another portion such as the lower surface of the covering portion.

In the above embodiment, the case where the plurality of electric wires 11 (conductors) of cable 10 include the plurality of signal wires 11S and the plurality of ground wires 11G has been described. However, the plurality of conductors of the “cable” of the present disclosure may include one signal wire and one ground wire. The “cable” of the present disclosure is not necessarily a flexible flat cable (FFC), and may be another cable such as a coaxial cable.

1. An electrical connector comprising:
a cable including a plurality of conductors and a covering portion, the plurality of conductors including at least one signal wire and at least one ground wire, the covering portion being configured to cover the plurality of conductors such that an end surface of each of the plurality of conductors is exposed; and
a terminal disposed to face the end surface of each of the conductors and electrically connected to the conductors,
wherein the end surface of each of the conductors is inclined with respect to a perpendicular surface perpendicular to an extension direction of each of the conductors,
wherein the terminal includes a base end portion connected to the end surface of each of the conductors and a leading end portion located opposite to the base end portion, and
wherein at least part of the terminal including the base end portion includes an inclined portion extending in a direction forming an obtuse angle with respect to each of the conductors, the direction being an inclination direction along the end surface.

2. The electrical connector according to claim 1, further comprising:
a conductor member disposed inside the covering portion or on a surface of the covering portion and connected to a ground,
wherein the terminal includes
a signal terminal connected to the end surface of the signal wire, and
a ground terminal connected to the end surface of the ground wire, and
wherein the ground terminal is connected to the conductor member, and the signal terminal is not connected to the conductor member and is separated from the conductor member.

3. The electrical connector according to claim 2,
wherein the covering portion includes a shield layer surrounding the conductors,
wherein the conductor member is disposed on a surface of the shield layer, and
wherein the shield layer is disposed at a position separated by a predetermined distance from the end surface of each of the conductors toward a side opposite to a side of the terminal in the extension direction.

4. The electrical connector according to claim 1,
wherein the conductors include a plurality of the signal wires arranged and a plurality of the ground wires arranged parallel to each other.

5. The electrical connector according to claim 4,
wherein the plurality of signal wires include a first signal wire and a second signal wire disposed adjacent to each other, and
wherein the plurality of ground wires include a first ground wire and a second ground wire each disposed at a position such that the first signal wire and the second signal wire are interposed between the first ground wire and the second ground wire.

6. The electrical connector according to claim 1,
wherein an end surface of the covering portion at which the end surface of each of the conductors is exposed is inclined with respect to the perpendicular surface so as to be along the end surface of each of the conductors, and the end surface of the covering portion and the end surface of each of the conductors are disposed on an identical plane.

7. The electrical connector according to claim 1,
wherein the terminal further includes an intersecting portion connected to the inclined portion and extending in a direction intersecting the inclined portion, and
wherein the intersecting portion is inclined so as to form an obtuse angle with respect to the inclined portion.

8. The electrical connector according to claim 1,
wherein the leading end portion of the terminal is configured to be elastically deformable.

9. The electrical connector according to claim 1, further comprising:
a housing configured to house an end portion of the cable and a plurality of the terminals; and
a holding member housed in the housing and configured to, in a state of being fixed to the housing, collectively hold the plurality of terminals.

10. The electrical connector according to claim 9,
wherein each of the plurality of terminals includes
as the inclined portion, a first inclined portion and a second inclined portion, and
an intermediate portion disposed between the first inclined portion and the second inclined portion and configured to connect the first inclined portion and the second inclined portion to each other, and
wherein the holding member is configured to collectively hold the intermediate portions of the plurality of terminals.

11. The electrical connector according to claim 1, further comprising:
as the cable, a first cable and a second cable,
wherein the leading end portion of each of a plurality of the terminals connected to the first cable is disposed at a position shifted in the extension direction from the leading end portion of each of a plurality of the terminals connected to the second cable.

12. A cable comprising:
a plurality of conductors including at least one signal wire and at least one ground wire; and
a covering portion configured to cover the plurality of conductors such that an end surface of each of the plurality of conductors is exposed,
wherein the end surface of each of the plurality of conductors is inclined with respect to a perpendicular surface perpendicular to an extension direction of each of the conductors.

13. The cable according to claim 12,
wherein the conductors include a plurality of the signal wires and a plurality of the ground wires arranged parallel to each other.

14. A connection assembly comprising:
the electrical connector according to claim 1; and
a substrate including a conductor portion electrically connected to the leading end portion of the terminal, the substrate being configured such that the electrical connector is mounted on the substrate.
